(19) United States
(12) Patent Application Publication
(10) Pub. No.: US 2015/0233256 A1
(43) Pub. Date: Aug. 20, 2015

(54) NOVEL ARCHITECTURES FOR ULTRA LOW THERMAL CONDUCTIVITY THERMAL BARRIER COATINGS WITH IMPROVED EROSION AND IMPACT PROPERTIES

(71) Applicant: General Electric Company, (US)

(72) Inventors: Krishnamurthy ANAND, Bangalore (IN); James Anthony RUUD, Delmar, NY (US); Surinder Singh PABLA, Greer, SC (US); Joshua Lee MARGOLIES, Niskayuna, NY (US); Padmaja PARAKALA, Bangalore (IN); Larry Steven ROSENZWEIG, Clifton Park, NY (US)

(73) Assignee: General Electric Company, Schenectady, NY (US)

(21) Appl. No.: 13/741,848

(22) Filed: Jan. 15, 2013

(51) Int. Cl. F01D 5/28; C23C 4/02; C23C 4/10; C23C 4/12

(52) U.S. Cl. CPC F01D 5/284; C23C 4/127; C23C 4/02; C23C 4/105; F05D 2300/2118

(57) ABSTRACT

A thermal barrier coating system for metal components in a gas turbine engine having an ultra low thermal conductivity and high erosion resistance, comprising an oxidation-resistant bond coat formed from an aluminum rich material such as MCrAlY and a thermal insulating ceramic layer over the bond coat comprising a zirconium or hafnium oxide lattice structure (ZrO₂ or HfO₂) and an oxide stabilizer compound comprising one or more of the compounds ytterbium oxide (Yb₂O₃), yttria oxide (Y₂O₃), hafnium oxide (HfO₂), lanthanum Oxide (La₂O₃), tantalum oxide (Ta₂O₅) or zirconium oxide (ZrO₂). The invention includes a new method of forming the ceramic-based thermal barrier coatings using a liquid-based suspension containing microparticles comprised of at least one of the above compounds ranging in size between about 0.1 and 5 microns. The coatings form a tortuous path of ceramic interfaces that increase the coating toughness while preserving the ultra low thermal conductivity.

The present invention relates to thermal barrier coatings applied to metal components exposed to high operating temperatures, such as the hostile thermal environment inside a gas turbine engine, including gas turbine blades and other metal components in direct contact with high temperature exhaust gasses. In particular, the invention relates to a new thermal barrier coating (“TBC”) system that includes a thermal-insulating ceramic layer having ultra low thermal conductivity and improved resistance to erosion, spallation or degradation resulting from repeated thermal cycling, particle impact and/or extended periods of use.

In exemplary embodiments, the new ceramic layer includes a zirconium-based lattice structure stabilized by compounds comprising one or more oxides of ytterbium, yttria, hafnium, lanthanum, tantalum and/or zirconium. The invention also encompasses a new method for applying the thermal barrier coatings to metal substrates using a suspension plasma spray technique where the coatings exhibit significantly improved physical properties.

### BACKGROUND OF THE INVENTION

In recent years, most gas turbine engines have been designed to operate at higher gas temperatures in an effort to improve their overall thermal efficiencies during prolonged periods of operation. However, as the operating gas temperatures of engines increase, the durability and expected life span of individual components, particularly metal components exposed to high temperature exhaust gases (often well above 2,000° F.) must correspondingly increase. Although significant advances have been made in recent years to improve the high temperature capability of key engine components (such as the combustor and augmentor sections) by using nickel and cobalt-based superalloys, even the latest superalloys are susceptible to damage resulting from oxidation, hot corrosion attack, spallation or high velocity particle erosion over time. Thus, the components in the hot gas sections of the engine do not always retain adequate mechanical strength properties during prolonged periods of use. The term “spallation” as used herein refers to the process by which fragments of material (spall) become vaporized or ejected from a metal surface due to impact, thermal cycling or high stress at elevated temperatures.

Typically, the critical metal components in the highest temperature zones of the engine are protected by applying some form of an environmental or thermal barrier coating system. The most common TBC systems include a metallic bond layer deposited directly onto the superalloy component surface, followed by an adherent thermal insulating ceramic layer that serves to protect the metal surface from high temperature gases. Many better known bond coats comprise an aluminum-rich material, such as a diffusion aluminide or an MCrAlY (where M is iron, cobalt or nickel and Y is yttria or other rare earth element).

In order to promote the adhesion between the bond coat and ceramic layer (and extend the service life of the engine), many TBC systems also include a thin overlay or “flash coating” (sometimes referred to as a “base ceramic layer”) having the same or slightly different ceramic composition positioned between the bond coat and top thermal insulating ceramic. Together, the bond coat and flash coating adhere the outer ceramic layer very tightly to the underlying superalloy surface while preventing oxidation and thermally protecting the underlying metal.

In the past, various ceramics, such as yttria-stabilized zirconia (YSZ), have been widely used as a preferred ceramic topcoat in TBC systems for gas turbine engines because YSZ can be readily deposited onto the bond coat (or the metal substrate) using either a plasma spray or other known high temperature physical vapor deposition technique. One such established coating in the gas turbine field includes zirconia (ZrO₂) stabilized with yttria (Y₂O₃), i.e, about 93 wt. % zirconia with about 7 wt. % yttria. A number of other available TBC systems rely on zirconia stabilized by magnesia (MgO) and/or other oxides as described in commonly-owned U.S. Pat. Nos. 4,328,285 and 5,236,745.

A continued concern of conventional thermal barrier coatings is the need to form a strong, adherent top ceramic layer that retains its thermal insulating properties but is less susceptible to erosion, spallation, impact damage or other deterioration when subjected to repeated thermal cycling. Most YSZ thermal barrier coatings are considered somewhat “porous” in nature (with porosities generally ranging between 5-20%) which reduce thermal conductivity but tend to make the coatings less mechanically stable and less resistant to erosion in harsh environments.

Unfortunately, some known methods for improving the mechanical strength of ceramic coatings result in higher thermal conductivities. For example, one known process that improves the erosion resistance of topcoats relies on a zirconia-based ceramic and wear-resistant outer coating composed of zircon or a mixture of silica, chromia and alumina densified by a chromic acid treatment. Although the process results in a more wear-resistant component, the densification of the coating actually increases the thermal conductivity, thereby nullifying much of the benefit obtained from the toughness of the coating under the extreme temperature conditions and thermal cycling of a gas turbine engine.

Other ceramic coatings with good strain tolerance and resistance to spallation have been developed by increasing the porosity of the coating, or by introducing microcracks having random internal discontinuities, or even by segmenting the ceramic layer as it is formed. The segmented structures (known in the industry as “vertically cracked structures”) have cracked boundaries that extend perpendicularly through the thickness of the ceramic and impart a relatively dense grain structure that increases cohesive bond strength. Again, however, even these latest zirconia-based TBCs tend to increase thermal conductivity and remain susceptible to erosion and impact damage from particles or debris present in high velocity exhaust streams.

Accordingly, a significant need still exists for a thermal barrier coating system that can combine the ability to resist wear (erosion) and/or spallation over time when subjected to a hostile thermal environment and yet exhibit a low thermal conductivity in the high temperature environment of a gas turbine engine. Preferably, such a coating system would be readily formable and employ an insulating ceramic layer having an ultra low thermal conductivity and be deposited in a manner that promotes both impact and erosion resistance without sacrificing the thermal insulating properties of the final coating. The TBC should also very strongly adhere to the base engine component and remain fully adherent during countless heating and cooling engine cycles. This latter requirement is particularly important given the different coefficients of thermal expansion between ceramic topcoat materials and the superalloy substrates they are designed to protect.

### BRIEF DESCRIPTION OF THE INVENTION

The present invention provides a new thermal barrier coating system for a metal component of a gas turbine engine having an ultra low thermal conductivity and high erosion resistance comprising (1) an oxidation-resistant bond coat formed from an aluminum rich material overlying the metal component; (2) an intermediate flash coating; and (3) a thermal insulating ceramic layer overlying the bond and flash coatings comprising a zirconium or hafnium base oxide lattice structure (ZrO₂ or HfO₂) and an oxide stabilizer compound (sometimes referred to as an oxide “dopant”) comprising one or more of the following compounds: ytterbium oxide (Yb₂O₃), yttria oxide (Y₂O3), hafnium oxide (HfO₂), lanthanum oxide (La₂O₃), tantalum oxide (Ta₂O₅) or zirconium oxide (ZrO₂). In exemplary embodiments, the aluminum rich bond coat includes a diffusion aluminide or MCrAlY where M is iron, cobalt or nickel and Y is yttria or other rare earth element. The intermediate ceramic flash coating nominally comprises a layer (e.g., 0.001 to 0.010 inches) of yttria-stabilized zirconia or ytterbia-stabilized zirconia positioned between the bond coat and thermal insulating ceramic.

The invention also encompasses a new method of creating the ceramic-based thermal barrier coating by first forming a liquid or aqueous-based suspension containing microparticles comprised of at least one of the above compounds and having a size range of about 0.1 to 5 microns, preferably between 0.2 and 2.6 microns. Nominally, the microparticles are fed as a suspension into a plasma spray torch which sprays the melted microparticles at high velocity onto the surface of the bond coat or flash coating to form a ceramic topcoat of substantially uniform thickness between about 150 and 1000 microns. As detailed below, the new coatings exhibit significantly lower levels of thermal conductivity and higher erosion resistance as compared to prior art ceramic coatings, including YSZ.

### BRIEF DESCRIPTION OF THE DRAWINGS

FIG. 1 is a cross-sectional view of a coated metal substrate (such as a turbine blade) depicting an exemplary thermal barrier coating comprising a bond coat, flash coating and top ceramic layer in accordance with the invention; and

FIG. 2 is a series of photomicrographs showing a thermal barrier coating applied to a substrate according to the invention using a suspension plasma spray technique (labeled “SPS” in the figure), resulting in a significantly lower room temperature erosion rate, implying an increased toughness as compared to a “baseline” prior art coating using a conventional high power axial plasma spray (“APS”) technique.

### DETAILED DESCRIPTION OF THE INVENTION

As noted above, the new thermal barrier coatings according to the invention result in a unique combination of improved physical properties, namely an increase in erosion resistance coupled with a significantly lower thermal conductivity (“k”). From a practical and commercial standpoint, the lower erosion and reduced thermal conductivity of the key hot gas components allows the gas turbine engine to operate for much longer periods of time at higher firing temperatures, thereby achieving significantly higher overall operating efficiencies. It has been found, for example, that the use of the new ultra low k thermal conductivity ceramic coatings described below can improve the combined cycle operating efficiency of a gas turbine engine by at least 0.1% points. The cooling benefits for TBCs engineered with the lower thermal conductivities also increase the overall combined cycle efficiency (including buckets, nozzles, etc.) by at least 0.1%. Thus, a 30% drop in the thermal k translates into an efficiency improvement of the combined cycle of approximately 0.1%, while a 50% drop in the k results in an efficiency improvement of about 0.2%. When applied to the most vulnerable hot sections of the engine (without changing the firing temperature), the lower k coatings reduce the base metal temperatures in the hottest zones by at least 25° F. and extend the expected life of the hot section components by up to 50%. In the end, the ceramic coatings described herein typically result in a 50% lower thermal conductivity compared to conventional coatings, including yttria-stabilized zirconia.

The reduced thermal conductivity achieved by the invention relates to the mixed pyrochlore structure of the coatings. That is, the incoherent vibrations that scatter phonons form a pyrochlore structure in which the loosely bound smaller ions partially replace the larger, lighter ions. That mechanism, along with intrinsic oxygen vacancies, reduces the phonon mean free path of the structure, which in turn reduces the thermal conductivity to an unusually low value. In order to ensure that the TBC has the ability to withstand solid particle erosion and foreign object damage, the invention also modifies the coating microstructure, making it more strain tolerant and resistant to crack initiation and propagation.

Applicants believe that while the special pyrochlore structure developed through compositional modifications achieve a significant reduction in thermal conductivity, the structure may exhibit some reduced mechanical properties, particularly fracture toughness. In order to counter that issue, the exemplary embodiments include microstructural modifications to improve both toughness and spall resistance. Applicants also understand that the improved physical properties of the coatings result from the significantly reduced grain size of microparticles used to form the coatings and the large number of interfaces per unit length introduced into the coatings after they have been applied onto the metal substrate. This is accomplished by a special method of processing in which the fine particles are entrained in a suspension and coated using a plasma gun to produce very fine surface splats with interfacial boundaries that impart a much higher degree of strain compliance. As a result, if a crack is generated in the TBC at a high operating temperature, it becomes much harder to propagate.

As noted, some of the new coatings comprise different combinations of Yb—Zr oxides having between 45 and 70% by weight Yb₂O₃. Other exemplary coatings may also include lanthanum-yttria oxides, zirconium oxides and pyrochlores (such as lanthanum-gadolinium and zirconium), all of which result in the significantly lower thermal conductivity (as compared to conventional YSZ coatings alone) as well as an erosion resistance equal to or greater than a conventional porous APS 7YSZ microstructure.

Microparticles useful in practicing the invention include ytterbium, yttria, hafnium, tantalum and/or zirconium and combinations thereof and range in size from about 0.1 to 5 microns in average diameter, preferably between about 0.2 and 2.6 microns. The microparticles melt when passed through a plasma spray torch and are then deposited onto a bond coat (or the flash coating) on the substrate surface in the manner described below. Because of the very small size and composition of the microparticles, under exemplary conditions the suspension spray forms a plurality of non-uniform splats on the contact surface that ultimately combine to form an integral ceramic coating having the improved physical properties.

Nominally, each of the individual splats on the substrate surface has a thickness of about 30-300 nanometers and a width (based on an average surface cross section) of about 1000-6000 nanometers. The exact thickness and size of the splats depend on the initial size of the microparticles used in the suspension plasma spray and the plasma spray conditions. For example, it has been found that a particle size of about 0.5 microns results in a splat about 0.05 microns in thickness, approximately 1 micron wide and generally circular in configuration as the microparticles impact the substrate surface and combine with other melted microparticles.

In practice, the microparticles according to the invention are placed into a suspension using an aqueous or organic liquid carrier (e.g., water or alcohol based) before being injected into a suspension plasma spray torch. The torch vaporizes or combusts the liquid carrier droplets containing microparticles in the suspension slurry, melting the particles and depositing them in melted form onto the contact surface. As the melted microparticles impact the surface at high velocity, they solidify into a thin, substantially uniform, coating as they cool. They also form well bonded interfaces with each other with randomly scattered nano-sized pores and nano-sized cracks that serve to reduce the potential erosion of the final coating without sacrificing the beneficial thermal insulating qualities of the ceramic. The specific chemistry of the suspension with proper dispersant additives also keeps the particles from settling too rapidly as they are fed to the spray torch.

Microparticles useful in the invention can be formed using various chemical techniques, such as co-precipitation or reverse co-precipitation with some controlled agglomeration to achieve a preferred size before being placed into a suspension. Co-precipitation helps to control the morphology of the precipitates and allow the average particle size to be optimized. A typical co-precipitation method begins in an acidic reaction environment that slowly changes to basic. Surprisingly, it has also been found that a reverse reaction in a strong basic environment may allow for slightly better control of the hydrolysis-complex process. In either method, the initial formation of the microparticles controls the size, crystalline phase structure and chemical composition of the starting powder.

A baseline set of physical properties for the new microparticles can be established as follows. Once the particle formation reaction is complete, the precipitate is filtered, washed with deionized water (nominally 2-3 times), calcined, ball milled, pressed into pellets and sintered. The resulting pellets consist of an ultra low thermal k composition which is reduced to powder form. The pelleting process provides a rapid fabrication process and keeps the compositions free from thermal spray processing artifacts. Before use, the pellets are also analyzed to determine their initial phase structure and thermal conductivity. Based on those initial measurements, a suitable process window can be established to obtain microparticle powders for use in the suspension plasma spray having an exact desired size and composition.

The process for forming the microparticles thus includes steps to control the particle size before creating a suspension and prior to introducing the suspension into an SPS gun. As noted, the preferred liquids for introducing the micron-sized powders into suspensions include water, linear alcohols such as methanol, ethanol, propanol and butanol, isopropyl alcohol, acetone or mixtures thereof as possible carrier fluids. Various other alcohols, organic liquids and aqueous-based mixtures can be used, provided they evaporate or efficiently combust in the downstream plasma flame without reacting or changing the composition, morphology or size of the suspended microparticles.

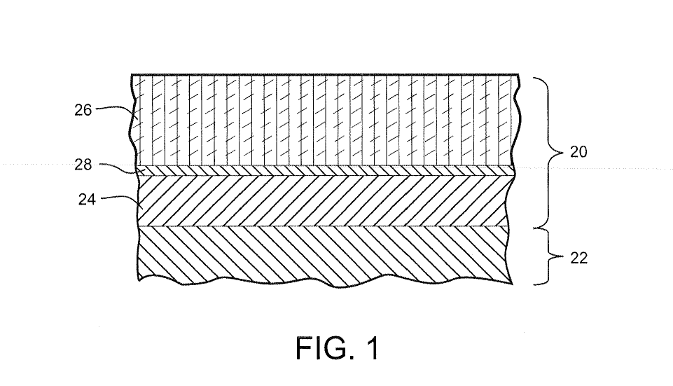

Turning to the figures, FIG. 1 is a cross-sectional view of a coated superalloy substrate 20 (such as a turbine blade or a combustor) depicting an exemplary thermal barrier coating system comprising a ceramic bond coat, flash coating, and a top ceramic layer in accordance with the invention. The coating system includes thermal-insulating ceramic layer 26 and bond coat 24 that directly overlies metal substrate 22, the latter of which typically forms the base material of a turbine blade. Suitable materials for the substrate include nickel and cobalt-based superalloys, although other known superalloys can be used. Bond coat 24 nominally comprises an aluminum-rich material, such as a diffusion aluminide or MCrAlY or a NiAl coating which is oxidation resistant and forms an initial thermal barrier to protect the substrate during exposure to elevated temperatures.

In order to promote adhesion between the bond coat and ceramic layer (and further extend the service life of the engine), the TBC system in FIG. 1 includes an overlay or flash coating 28 which comprises a high toughness ceramic material such as a standard yttria stabilized zirconia, ytterbia stabilized zirconia or other stabilized zirconia compositions. Flash coating 28 ranges in thickness between 0.001 and 0.010 inches and serves to further protect the underlying superalloy substrate 22 from oxidation and thermal resistance while providing a surface to which the topcoat ceramic tenaciously adheres.

Together, the bond coat and flash coating adhere the TBC very tightly to the underlying superalloy surface while preventing oxidation and thermally protecting the metal component. Ceramic layer 26 is formed from the microparticles as described above. The top ceramic layer also forms a strain-tolerant microstructure attained by depositing the ceramic layer using an SPS deposition technique. As indicated above, the median microparticle size ranges between about 0.1 and 5 microns, preferably between about 0.2 to 2.6 microns depending on the exact composition and morphology.

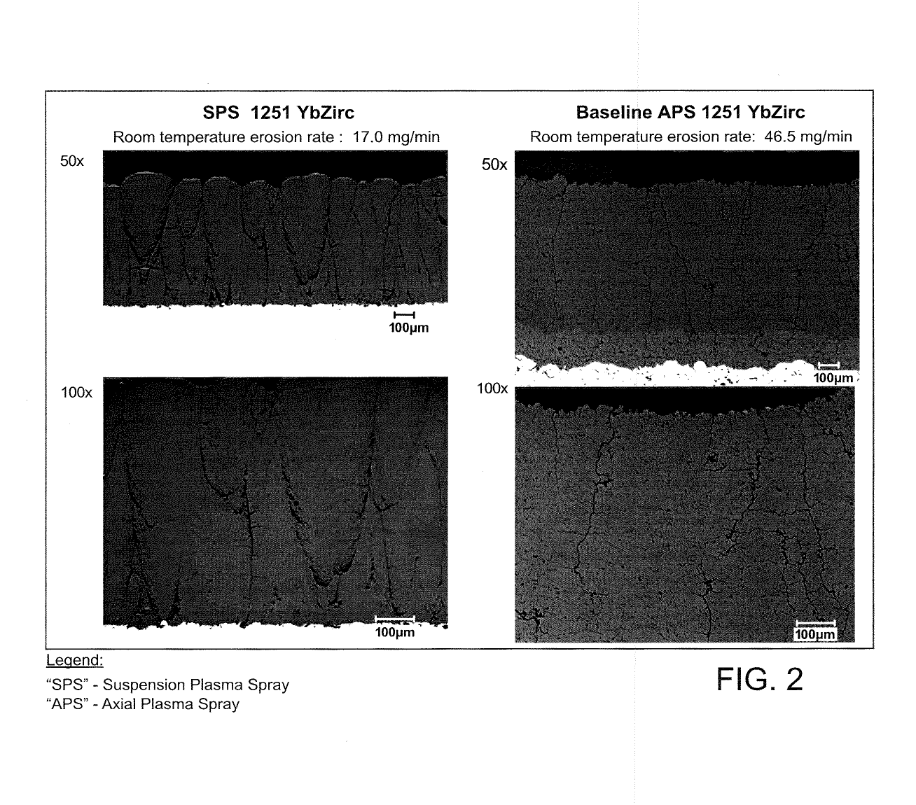

FIG. 2 is a series of photomicrographs showing a thermal barrier coating applied to a substrate according to the invention using a suspension plasma spray (“SPS”) technique. As FIG. 2 makes clear, the resulting coating has a significantly lower room temperature erosion rate as compared to a baseline coating using a conventional high power axial plasma spray (“APS”) technique. FIG. 2 depicts the coating at two different magnification levels (50× and 100×) with an erosion rate at room temperature of about 17 mg/min. In contrast, the baseline APS coating resulted in a significantly higher erosion rate (approximately about 250% higher), namely 46.5 mg/min.

Table 1 below provides a comparison of the erosion rates and thermal conductivities of coatings according to the invention (having a 30% drop in thermal conductivity) using a suspension plasma spray technique as compared to the baseline coating using an APS (Plazjet) technique.

TABLE 1
Comparison of Erosion Rate and Thermal Conductivity Utilizing Powder
Composition Yb₄Zr₃O₁₂ (65% Yb₂O₃, 35% ZrO₂)

| | Median | Room | Thermal |
|---|---|---|---|
| | particle size, | Temperature | conductivity |
| Coating | d50, | Erosion rate | @ 890° C. |
| method | (microns) | (mg/min) | (W/m-° K.) |
| SPS | 0.5 | 17.0 | 1.2 |
| SPS | 2.6 | 18.8 | 1.25 |
| Baseline APS | 47.7 | 46.5 | 1.4 |
| (Plazjet) | | | |

The following test procedure was used for the SPS coating composition reflected in Table 1. A feedstock powder composition of Yb₄Zr₃O₁₂ (65% Yb₂O₃, 35% ZrO₂) was deposited onto 25 mm×75 mm×2.5 mm thick coupons of Alloy HX substrates (Hastelloy X or Inconel HX) roughened with 60 mesh white aluminum oxide media at 60 psi air pressure. The coatings were deposited on the surface using a Northwest Mettech Axial III DC plasma torch. The feedstock material comprising Yb₄Zr₃O₁₂ had a mean particle size (d₅₀) of between 0.5 μm and 2.6 μm, with the particles being suspended in ethanol at 20 wt % using polyethyleneimine as a dispersant (approximately 0.2 wt % of the solids). The suspension was injected into the plasma torch through the center tube of a tube-in-tube atomizing injector using a nitrogen atomizing gas sent through the outer tube. A ⅜″ diameter nozzle was used at the end of the torch with the power set to about 100 kW.

The suspension feed rate for the Table 1 coatings was approximately 23 grams/minute or about 0.6 pounds per hour of Yb₄Zr₃O₁₂ and the plasma torch was rastered across the substrate at 600 mm/sec with a 4 mm index between stripes. The spray distances between the torch nozzle and the substrate samples was 75 mm resulting in coating thickness of about 650-700 μm. The SPS plasma spray parameters were 300 slpm total gas flow with 30% nitrogen, 10% hydrogen, and 60% argon, with a nitrogen carrier gas of 6 slpm. A current of 180 A was used for each of the three electrodes, resulting in a total gun power of approximately 100 kW.

In addition to the coatings in Table 1, other coatings according to the invention have been produced using a 10 wt. % slurry containing 0.6 μm YbZ microparticles suspended in ethanol using spray parameters similar to those indicated above. The additional coatings based on slightly different YbZ suspensions contained d50 particle sizes ranging in size between about 0.2 μm and 2.6 μm. For purposes of comparison, the “Baseline” prior art APS sample identified above in Table 1 used a mean particle size for the YbZ of about 47.7 μm, with the erosion rates and thermal conductivity measured at the same temperatures as the SPS samples.

In summary, Table 1 illustrates the improved mechanical properties of ceramic topcoats using the microparticles and SPS coating method according to the invention, namely a significantly lower room temperature erosion rate coupled with a lower thermal conductivity—two physical properties that ultimately result in substantial improvements to the overall efficiency of a combined cycle gas turbine engine.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A thermal barrier coating system for a metal component of a gas turbine engine having ultra low thermal conductivity and high erosion and spallation resistance, said coating system comprising:
an oxidation-resistant bond coat comprised of an aluminum rich material overlying said metal component; and
a thermal insulating ceramic layer having splat interfaces overlying said bond coat, said ceramic layer comprising a zirconium or hafnium oxide lattice structure and one or more oxide stabilizer compounds comprising ytterbium oxide, yttria oxide, hafnium oxide, lanthanum oxide, tantalum oxide or zirconium oxide.

2. A thermal barrier coating according to claim 1, wherein said one or more oxide stabilizer compounds comprise about 65 wt. % yttribrium oxide and 35 wt. % zirconium oxide.

3. A thermal barrier coating according to claim 1, wherein said oxide stabilizer compounds comprise lanthanum oxide and yttria oxide.

4. A thermal barrier coating according to claim 1, wherein said oxide stabilizer compounds comprise substantially equal amounts of ytterbium oxide, yttria oxide, hafnium oxide, tantalum oxide and zirconium oxide.

5. A thermal barrier coating according to claim 1, wherein said oxide stabilizer compounds comprise substantially equal amounts of lanthanum oxide, ytterbium oxide, yttria oxide, hafnium oxide tantalum oxide and zirconium oxide.

6. A thermal barrier coating system according to claim 1, wherein said aluminum rich bond coat comprises a diffusion aluminide or an MCrAlY where M is iron, cobalt or nickel and Y is yttria or other rare earth element.

7. A thermal barrier coating system according to claim 1, further comprising a ceramic flash coating between said bond coat and said thermal insulating ceramic.

8. A method of forming a ceramic-based thermal barrier coating having an ultra low thermal conductivity and low erosion rate on a metal substrate, said method comprising the steps of:
applying an aluminum-rich metallic bond coat onto the surface of said metal substrate;
forming a liquid-based suspension containing microparticles comprised of at least one of the compounds ytterbium oxide, yttria oxide, hafnium oxide, lanthanum oxide, tantalum oxide or zirconium oxide;
feeding said liquid-based suspension containing microparticles into a suspension plasma spray torch; and
spraying melted microparticles onto the surface of said bond coat.

9. A method according to claim 8, wherein said melted microparticles form a ceramic coating having a substantially uniform thickness of between about 150 and 1000 microns.

10. A method according to claim 8, wherein said ultra low thermal conductivity ranges between 1.2 and 1.25 when measured at 890° C.

11. A method according to claim 8, wherein the room temperature erosion rate for said thermal barrier coating at room temperature ranges between 17-19 mg/min.

12. A method according to claim 8, wherein the average size of said microparticles ranges between 0.1 and 5 microns.

13. A method according to claim 8, wherein said step of spraying said melted microparticles onto the surface of said bond coat is carried out using suspension plasma spray.

14. A method according to claim 8, wherein said metal substrate comprises a nickel or cobalt-based superalloy.

15. A thermally insulated metal component for use in a gas turbine engine, comprising:
a base metal substrate;
an oxidation-resistant bond coat comprising an aluminum rich material overlying said base metal substrate; and
a thermal insulating ceramic layer overlying said bond coat, said ceramic layer comprising a zirconium or hafnium oxide lattice structure and one or more oxide stabilizer compounds comprising ytterbium oxide, yttria oxide, hafnium oxide, lanthanum oxide, tantalum oxide or zirconium oxide.

16. A thermally insulated metal component according to claim 15, further comprising a ceramic flash coating containing an aluminide or platinum aluminide positioned between said bond coat and said thermal insulating ceramic layer.

17. A thermally insulated metal component according to claim 15, wherein said base metal substrate comprises a cobalt-based superalloy and said bond coat comprises an MCrAlY.

18. A thermally insulated metal component according to claim 15, wherein said wherein said oxide stabilizer compounds comprise about 65 wt. % yttribrium oxide and 35 wt. % zirconium oxide.

19. A thermally insulated metal component according to claim 15, wherein said oxide stabilizer compounds comprise lanthanum oxide and yttria oxide.

20. A thermally insulated metal component according to claim 15, further comprising a ceramic flash coating positioned between said bond coat and said thermal insulating ceramic layer.
